(19) United States
(12) Patent Application Publication
(10) Pub. No.: US 2013/0070663 A1
(43) Pub. Date: Mar. 21, 2013

(54) Method and Arrangement in a Telecommunication System

(71) Applicants: Fredrik Gunnarsson, Linkoping (SE); Stefan Engström, Linkoping (SE); Gunnar Mildh, Sollentuna (SE); Walter Gerhard Alois Müller, Upplands Vasby (SE); Stefan Henrik Andreas Wager, Espoo (FI)

(72) Inventors: Fredrik Gunnarsson, Linkoping (SE); Stefan Engström, Linkoping (SE); Gunnar Mildh, Sollentuna (SE); Walter Gerhard Alois Müller, Upplands Vasby (SE); Stefan Henrik Andreas Wager, Espoo (FI)

(73) Assignee: TELEFONAKTIEBOLAGET L M ERICSSON (PUBL), Stockholm (SE)

(21) Appl. No.: 13/634,491

(22) PCT Filed: May 3, 2012
(86) PCT No.: PCT/SE12/50457

§ 371 Date: Sep. 12, 2012

Related U.S. Application Data
(60) Provisional application No. 61/487,155, filed on May 17, 2011.

(51) Int. Cl. H04W 36/38

(52) U.S. Cl. CPC H04W 36/38
USPC 370/315

(57) ABSTRACT

The present invention relates to a method in a serving base station (130) for controlling handover of a relay node (140) to a target cell (150A) controlled by a target base station (150). The method comprises the steps of
obtaining information (91) indicating if the target base station and/or the target cell supports handling of relay nodes or not;
avoiding handover of said relay node to said target cell in case the target base station and/or the target cell does not support handling of relay nodes (94).

The invention furthermore relates to a base station for performing said method.

### FIELD OF THE INVENTION

The present invention relates to the field of mobile relay nodes in a telecommunication system.

### BACKGROUND

One important aspect with wireless networks is to ensure that the network is simple to deploy and cost efficient to operate. The vision is that the system shall be self-organizing in as many aspects as possible. Furthermore, good coverage is important when aiming at a mobile broadband experience, both outdoors and indoors. Typically, this coverage is provided via macro base stations with dedicated transport connections, but it is also possible to consider self-backhauling base stations or relays where the same technology is used both for user data between a mobile terminal, also referred to as a User Equipment, UE, and the relay and for the transport connection between the relay and a base station with a dedicated transport connection.

The architecture of the 3G Long Term Evolution (LTE) system is shown in FIG. 1, wherein base stations, in LTE terminology referred to as eNodeBs, are connected via an X2 interface. The eNodeBs are connected to the core network using an S1 interface. A control node called Mobility Management Entity, MME, processes the signaling between a User Equipment, UE, and the Core Network (CN) and provides Visitor Location Register (VLR) functionality for the Evolved Packet System (EPS). The MME handles a relay node as a UE with some small additions.

In LTE the downlink uses orthogonal frequency division multiplexing (OFDM) while the uplink uses a single carrier modulation method known as discrete Fourier transform spread OFDM (DFT-S-OFDM).

Cells are identified locally by a signal sequence from an enumerated set. In LTE there are 504 signal sequences, each associated to a Physical Cell Identity (PCI). Furthermore, the cell broadcasts an E-UTRAN Cell Identifier, which uniquely identifies the cell within the Public Land Mobile Network (PLMN). In 3GPP TS 36.331, relating to RRC (Radio Resource Control) procedures, the combination of PLMN-ID, which is the first PLMN-ID in case of a list, and the E-UTRAN cell identifier is denoted the Evolved Cell Global Identifier (ECGI) and is broadcasted in the CellGlobalIdEUTRA information element.

Furthermore, the application protocol over the X2 interface (X2AP 36.423) specifies the cell identifiers used between eNBs and the application protocol over the S1 interface (S1AP 36.413) specifies the cell identifiers used between eNB and the core network. The 28 bit cell identifier is divided into two parts:
eNB ID identifying the eNB
identifier of cells served by the eNB

A macro eNB is identified by 20 bits, which gives 8 bits to identify its cells, and a home eNB is identified by 28 bits and consequently only one cell. FIG. 2 illustrates the relation between the cell and eNB identifiers.

If the X2AP/S1AP definition of E-UTRAN Cell Identifier is used as the cell identity broadcasted by the E-UTRAN cells, then a relay node can separate the eNB ID from the cell identifier part.

Mobile terminal mobility from one eNB to another can be handled either via the S1 interface involving the MME or via an X2 interface directly between the eNBs, see FIG. 1. The eNB handling the mobile terminal before a handover is referred to as a serving eNB or a source eNB, while an eNB to which the mobile terminal may be handed over is referred to as a target eNB. A cell controlled by said target eNB to which the mobile terminal may be handed over to is referred to as a target cell or candidate cell.

### S1 Handover and Neighbor Relations

When a mobile detects a candidate cell with favorable radio conditions it reports the candidate cell's PCI to its serving eNB. There are two alternatives for this reporting. Either the serving eNB is aware of the ECGI of the cell using this PCI in the vicinity and the eNB ID of the eNB serving the candidate cell (neighbor relation information), or the serving eNB may request the mobile terminal to decode the ECGI and report back to the serving eNB or alternatively use some other way to determine the ECGI of the candidate cell. The ECGI is used to determine or lookup the identity of the eNB serving the candidate cell.

The association between PCI on the one hand and ECGI and eNB identity, ID, on the other can be seen as the relevant information concerning a neighbor relation when S1 is used for handovers.

Eventually, when the PCI to ECGI association is known the serving eNB determines that the mobile terminal should be handed over to the eNB serving the target cell, and initiates handover preparation signaling as illustrated by FIG. 3.

First, a HANDOVER REQUIRED message is sent to the MME comprising
the eNB ID of the eNB serving the target cell;
a Source eNB to Target eNB Transparent Container including the ECGI of the target cell as well as information about established radio access bearers and radio resource control information;
a cause for requiring handover, e.g. “Handover Desirable for Radio Reasons”.

This information is forwarded to the target eNB by the MME in a HANDOVER REQUEST message.

If the preparation of resources is successful at the target eNB it responds to the MME with a HANDOVER REQUEST ACKNOWLEDGE message; otherwise it responds with a HANDOVER FAILURE message including a failure cause, i.e. a reason for failure. If the preparations were successful, MME signals a HANDOVER COMMAND to the source eNB, otherwise it signals HANDOVER PREPARATION FAILURE, see FIG. 4, including a failure cause, for example “HO target not Allowed”.

### X2 Handover and Neighbor Relations

When a mobile detects a candidate cell with favorable radio conditions it reports the candidate cell's PCI to its serving eNB. There are two alternatives when reporting this:
The serving eNB is unaware of the PCI, and may request the mobile to decode the ECGI and report back to the serving eNB (or use some other means to disclose the ECGI of the candidate cell). The ECGI is either used directly to lookup the connectivity information to the eNB serving the candidate cell, or the ECGI can be used to determine or lookup the eNB identity, ID, which in turn is used to lookup the connectivity information to the eNB serving the candidate cell; or
the serving eNB is aware of the PCI, and thereby have stored information about the connectivity information to the eNB serving the candidate cell.

The association between PCI on the one hand and ECGI, eNB iD and eNB connectivity information on the other can be seen as the relevant information concerning a neighbor relation when the X2 interface is used for handovers.

Eventually, when the PCI to ECGI association is known, the serving eNB decides that the mobile terminal should be handed over to the eNB serving the target cell, and initiates handover preparation signaling as illustrated in FIG. 5. First, a HANDOVER REQUEST message is sent to the target eNB comprising
the ECGI of the target cell;
UE context information including information about the UE, defined measurement procedures, UE MME relations etc;
a cause for requiring handover, e.g. “Handover Desirable for Radio Reasons”.

If the preparation of resources is successful at the target eNB it responds to the source eNB with a HANDOVER REQUEST ACKNOWLEDGE message; otherwise it responds with a HANDOVER PREPARATION FAILURE message, see FIG. 6, including a failure cause, e.g. “HO Target not Allowed”.

Furthermore, if the X2 interface is established between a first eNB and a second eNB, then the eNBs can exchange configuration information over X2. The first eNB sends an eNB CONFIGURATION UPDATE message to the second eNB, which responds with either eNB CONFIGURATION UPDATE ACKNOWLEDGE or eNB CONFIGURATION UPDATE FAILURE.

The eNB CONFIGURATION UPDATE message comprise
served cells to add;
served cells to modify;
served cells to delete.

The served cells to delete are only identified by their ECGI, while each served cell to add or modify is associated with information about its neighbors (PCI, ECGI and frequency of operation) and with served cell information comprising PCI and ECGI.

In addition to the user and control planes specified in 3GPP, there is architecture for network management to support configuration, equipment management, fault management, performance management etc. The management system assumed here is shown in FIG. 7. However, other more decentralized management systems might also be considered. The eNodeBs are managed by a domain manager (DM), also referred to as the operation and support system (OSS). Sometimes the individual eNBs are considered handled by an element manager (EM), which is a part of the DM. Typically, a DM manages equipment from the same vendor. The DM tasks include configurations of the eNodeBs, fault management and performance monitoring. The latter can mean that extensive data from events and counters is regularly transferred from the network elements up to the DM.

A DM may in turn be managed by a network manager, NM. Two eNodeBs are interfaced by X2, whereas the interface between two DMs is referred to as Itf-P2P. This means that multi-vendor management can be handled either via the common NM, or via the Itf-P2P interface.

Self-backhauling relays are considered for LTE Advanced, see FIG. 8. LTE-Advanced extends LTE Rel-8 with support for relaying as a tool to improve e.g. the coverage of high data rates, group mobility, temporary network deployment, the cell-edge throughput and/or to provide coverage in new areas. FIG. 8 shows schematically the concept of self-backhauling relays, where the relay node, RN, 140 is wirelessly connected to a donor cell of a donor eNB, DeNB, 130 via a Un interface, and User Equipments, UEs, 120 connect to the RN via a Uu interface. The DeNB further connects the RN to the core network, i.e. the evolved packet core (EPC)

The Un connection can be
inband, in which case the eNB-to-RN link share the same band with direct eNB-to-UE links within the donor cell.
outband, in which case the eNB-to-RN link does not operate in the same band as direct eNB-to-UE links within the donor cell.

LTE-Advanced supports RNs that have characteristics that comprise:
it control cells, each of which appears to a mobile terminal as a separate cell distinct from the donor cell;
the cells have their own Physical Cell ID which is associated to waveforms used by mobile terminal to identify the cell and transmit their own synchronization channels, reference symbols, and other cell specific waveforms, etc;
in the context of single-cell operation, the mobile terminal receives scheduling information and data transmission feedback directly from the RN and sends its control channels to the RN;
it shall appear as an eNodeB to legacy mobile terminals, i.e. it shall be backwards compatible;
it may be nomadic, meaning that it may change donor eNBs over time, either via events such as handovers, or more disruptive events such as physical relocations of the relay node;
it may be inactive at times for example to save energy.

To a large extent, a relay node is perceived as any eNB by a UE. For example, the connections X2 and S1 between RN and other eNBs are established (partly over Un) and the management system architecture, also referred to as Operation and Maintenance, O&M, architecture, in FIG. 7 applies also to RN. It should be noted that RN and DeNB may be handled by different DM.

Furthermore, from the perspective of the serving eNB, a relay node is handled to a large extent as any UE served by the serving eNB. For example, when the relay node is installed, it may attach to the network via the UE attach procedure, and not until when RRC connectivity is established, the serving eNB may be informed by the core network that the UE in fact is a relay node.

One alternative of informing the serving eNB of the relay node status is that the relay node performs an attach procedure as any UE. Part of this procedure involves signaling a Non Access Stratum, NAS, message to the core network together with information about the attaching UE.

From this information, the core network is informed that the attaching UE is actually a relay node, and informs the serving eNB about the relay node status. Typically, an associated MME/MME pool signals this information, which may have been obtained by acquiring information from subscription databases such as Home Subscriber Server, HSS.

Another alternative is that the relay node indicates directly to the serving eNB that it is a relay node. This indication could be carried over RRC or some other signaling means. The RRC signaling options comprise
a dedicated RRC message
a dedicated establishment cause in an RRCConnectionRequest message
a dedicated indication in an RRCConnectionSetupComplete message.

Not all base stations, such as eNBs, and/or cells may be capable of handling relay nodes and act as donor cells, since the base station needs dedicated functionality such as X2 and S1 proxies in order to support relay nodes. Another situation is if a first relay node selects another, second, relay node to attach to, and unless multi-hop relaying involving more than one relay node in the communication between UEs and a serving eNB is supported, the second relay node is not capable of supporting the first relay node.

Mechanisms to handle this at relay node startup has been proposed in prior art, but these methods are cumbersome and inefficient when considering relay node mobility from one source eNB serving the relay node to a target eNB.

### SUMMARY

It is therefore an objective of embodiments of the present invention to improve the handling of relay node mobility.

In case of nomadic relay nodes, a different eNB might become more favorable as donor eNB than the current serving donor eNB. In this case, the serving donor eNB might consider handing over the relay node to a target eNB. Essentially, the same procedures as for handover of a UE is applied for handover of a relay node.

Embodiments of this invention relates to mechanisms for informing about relay node support from one radio network node to another radio network node.

A first aspect of an embodiment of the invention relates to a method in a serving base station for controlling handover of a relay node to a target cell controlled by a target base station. The method comprises the steps of
obtaining information indicating if the target base station and/or the target cell supports handling of relay nodes or not;
avoiding handover of said relay node to said target cell in case the target base station and/or the target cell does not support handling of relay nodes.

In a specific embodiment, the method comprises the steps of
indicating to the target base station in handover preparation signaling that said handover preparation concerns a relay node;
obtaining information if the target base station and/or the target cell supports handling of relay nodes or not by receiving a response from the target base station.

Said handover preparation signaling may take place over an S1 interface via an MME, or alternatively over an X2 interface between the serving base station and the target base station.

Said response from the target base station may comprise a rejection of handover in case the target base station and/or the target cell does not support handling of relay nodes.

Said response may furthermore comprise information relating to the cause for rejecting handover.

Said rejection of handover may comprise a HANDOVER PREPARATION FAILURE message.

Furthermore, the method may optionally comprise the step of storing information related to the rejection of handover.

According to a specific embodiment, the information indicating if the target base station and/or the target cell supports handling of relay nodes or not is obtained as neighbor relation information.

Said neighbor relation information may be received over an X2 interface between base stations. Said neighbor relation information may in a particular embodiment be comprised in an eNB CONFIGURATION UPDATE message.

Alternatively, said neighbor relation information is received via a management system node.

A second aspect of an embodiment of the invention relates to a base station capable of acting as serving base station, said base station comprising a processor configured for controlling handover of a relay node to a target cell controlled by a target base station, said processor being configured to
obtain information indicating if the target base station and/or the target cell supports handling of relay nodes or not;
avoid handover of said relay node to said target cell in case the target base station and/or the target cell does not support handling of relay nodes.

Hereby, said obtained information is used to determine if handover of said relay node should be triggered or not such that handover of the relay node is avoided in case the target base station and/or the target cell does not support handling of relay nodes.

According to a specific embodiment, the base station comprises
a transmitter configured to indicate to the target base station in handover preparation signaling that said handover preparation concerns a relay node;
a receiver configured to obtaining information if the target base station and/or the target cell supports handling of relay nodes or not by receiving a response from the target base station.

Said transmitter may be configured to send said handover preparation signaling over an S1 interface via an MME or over an X2 interface between a serving base station and a target base station.

Said response may comprise a rejection of handover in case the target base station and/or the target cell does not support handling of relay nodes.

Said response may comprise information relating to the cause for rejecting handover.

Said rejection of handover may comprise a HANDOVER PREPARATION FAILURE message.

Optionally, said processor may comprise circuitry for storing information related to the rejection of handover.

In a specific embodiment, the base station comprises a receiver configured to receive neighbor relation information to obtain the information indicating if the target base station and/or the target cell supports handling of relay nodes or not, said information being comprised in the neighbor relation information.

The receiver may be configured to receive neighbor relation information over an X2 interface.

The receiver may be configured to receive neighbor relation information comprised in an eNB CONFIGURATION UPDATE message.

The receiver may be configured to receive neighbor relation information via a management system node.

Embodiments of the invention involve advantages such as efficient relay node mobility, since unsuccessful handover preparations can be avoided, or halted at early stages.

Other objects, advantages and novel features of the invention will become apparent from the following detailed description of the invention when considered in conjunction with the accompanying drawings.

### BRIEF DESCRIPTION OF THE DRAWINGS

FIG. 1 illustrates the LTE architecture showing logical interfaces between eNBs (X2) and between eNB and MME/S-GW (S1);

FIG. 2 illustrates the relation between different cell and eNB identifiers in X2AP and S1AP. (* In S1AP, the notation “Cell Identity” is used instead of “E-UTRAN Cell Identifier”, but the meaning is the same.);

FIG. 3 illustrates a signaling sequence for successful S1 handover preparation;

FIG. 4 illustrates a signaling sequence for S1 signaling at handover preparation failure;

FIG. 5 illustrates a signaling sequence for successful X2 handover preparation;

FIG. 6 illustrates a signaling sequence for X2 signaling at handover preparation failure;

FIG. 7 illustrates an assumed network management system;

FIG. 8 illustrates the concept of self-backhauling relays;

FIG. 9 shows a flowchart of a general embodiment of the invention performed by a serving base station;

FIG. 10 shows a flowchart of a first specific embodiment of the invention performed by a serving base station;

FIG. 11 shows a flowchart of a second specific embodiment of the invention performed by a serving base station;

FIG. 12 shows a schematic illustration of a base station;

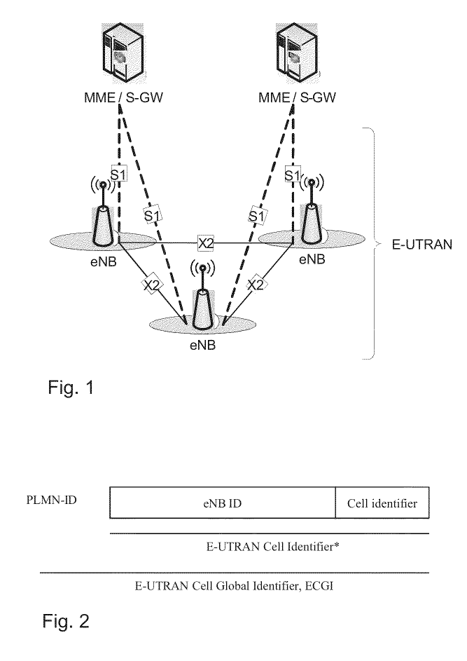

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary details.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

User equipments may be referred to as mobile telephones, cellular telephones, laptops, or surf plates with wireless capability, just to mention some further examples. The user equipments in the present context may be, for example, portable, pocket-storable, hand-held, computer-comprised, or vehicle-mounted mobile devices, enabled to communicate voice and/or data, via the RAN, with another entity, such as another user equipment or a server. The concept of user equipment also comprises devices with communication capability of machine-type character such as sensors, measurement devices etc that not necessarily is in any interaction with a user.

Embodiments of the invention relate to relay support information signaling over X2, S1 and via the management system. Both S1 and X2 could according to embodiments be extended such that the serving, or source, eNB indicates that the handover preparation request concerns a relay node, and the target eNB can respond negatively if the intended cell at the target eNB does not support relay nodes. Furthermore, X2 can be extended to allow a first eNB to proactively update neighboring second eNBs that particular cells served by the first eNB do support or do not support relay nodes, which means that unsuccessful relay node handover preparation attempts can be avoided. Finally, the information indicating if a target base station and/or a target cell for possible handover of said relay node supports handling of relay nodes could be conveyed via the management system, for example as part of information exchange when new neighbor relations are established.

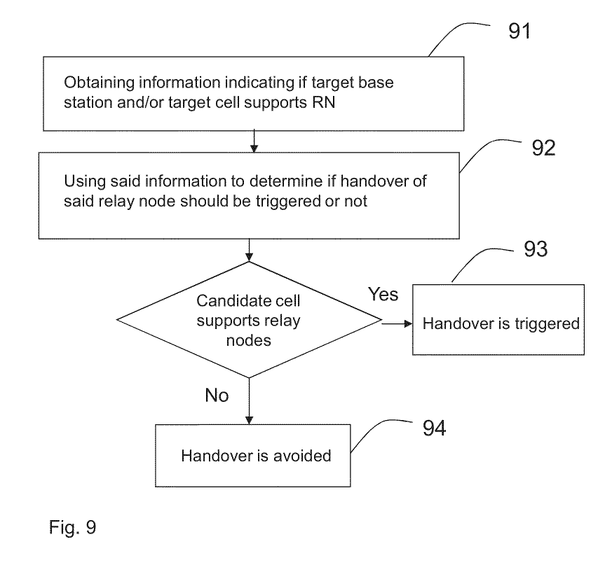

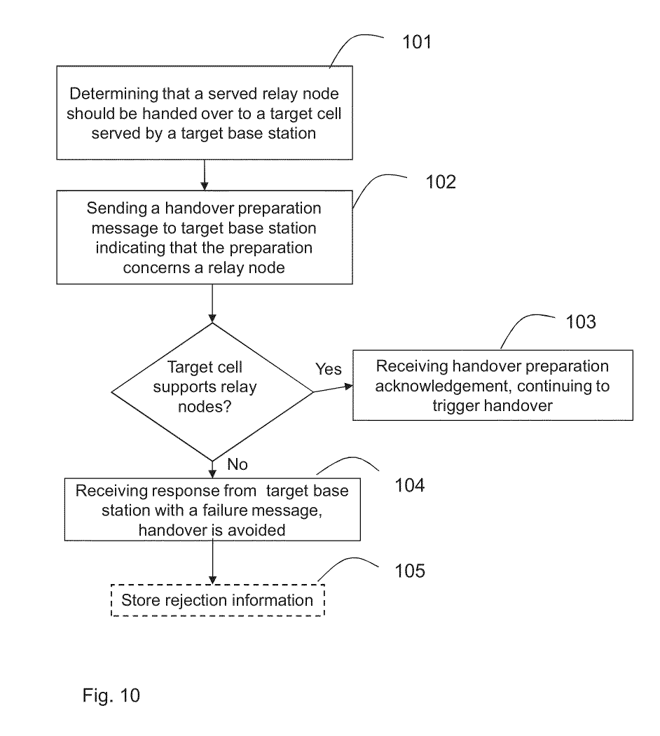

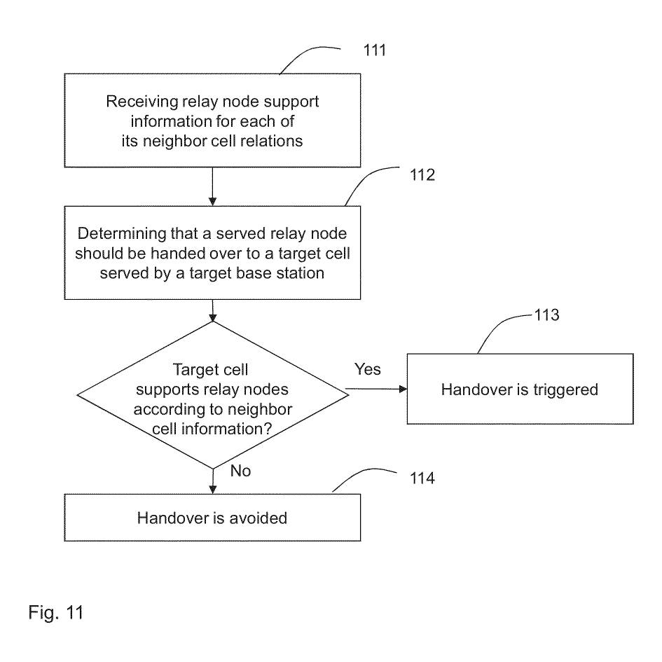

FIG. 9 shows a flowchart of a general method according to embodiments of the invention. In step 91, a serving base station 130, acting as donor base station for a relay node 140, obtains information indicating if a target base station 150 and/or a target cell 150A for possible handover of said relay node 140 supports handling of relay nodes. The obtaining of this information can be carried out in different ways which will be further described in relation to FIGS. 10 and 11.

In step 92, the serving base station uses the obtained information to determine if handover of the relay node 140 should be performed to said target cell 150A.

As indicated in step 93, if said target base station 150 and target cell 150A support handling of relay nodes, handover to the target cell 150A can be triggered. On the other hand, as indicated in step 94, if said target base station 150 and/or target cell 150A does not support handling of relay nodes, handover to the target cell is avoided.

Thus, in general, embodiments of the invention concern triggering or avoiding handover depending on whether the target cell 150A served by the target base station 150 supports handling of relay nodes or not. It should be noted that the steps comprised in FIG. 9 in different embodiments may include several different and alternative sub-steps, some of which will be described in the following.

Two different embodiments relating to the step of obtaining information indicating if a target base station 150 and/or a target cell 150A supports handling of relay nodes will be described in the following.

Handover Preparation Requests with Relay Node Indications

This embodiment is illustrated in general terms with a flowchart in FIG. 10.

In step 101, the serving, or source, base station 130 determines that a served relay node 140 should be handed over to a target cell 150A served by a target base station 150.

In step 102 the serving (source) eNB indicates at handover preparation to the target eNB that this handover preparation concerns a relay node in a handover preparation message to the target base station. This message can be sent via MME in case of S1 handover or via the X2 interface in case of X2 handover. The indication that the handover preparation concerns a relay node can be implemented as
a. a dedicated cause in the HANDOVER REQUIRED and HANDOVER REQUEST messages in case of S1 handover, or in the HANDOVER REQUEST message in case of X2 handover;
b. a relay node indication included in the Source eNB to Target eNB Transparent Container the HANDOVER REQUIRED and HANDOVER REQUEST messages in case of S1 handover;
c. a relay node indication included in the UE Context information in the HANDOVER REQUEST message in case of X2 handover.

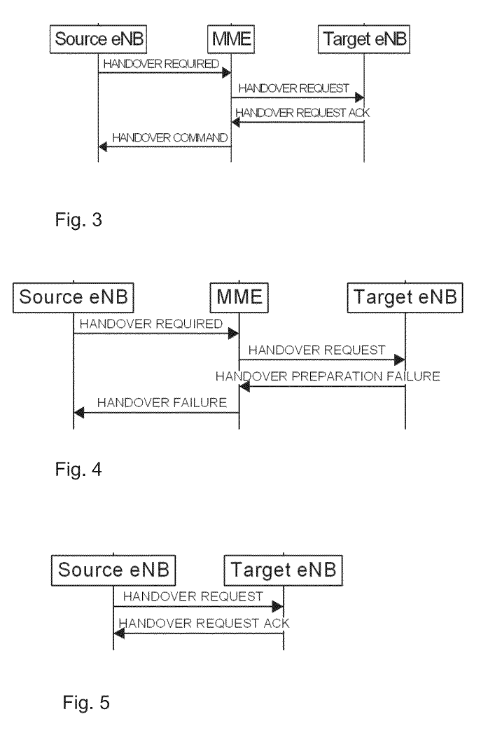

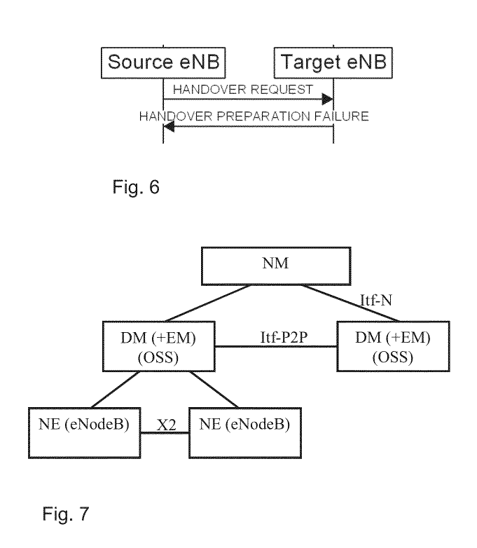

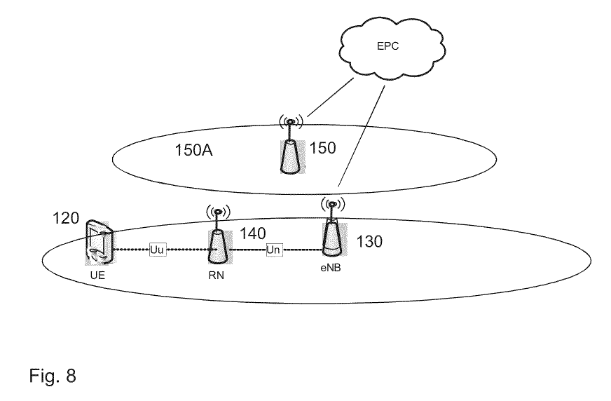

If the target cell served by the target eNB supports handling of relay nodes, then the handover procedure for any mobile terminal applies, see step 103. That is, in case the target cell served by the target eNB supports handling of relay nodes, the serving base station obtains information of this by receiving a handover command from the target base station via the MME, see FIG. 3, or a handover request ACK from the target base station, see FIG. 5. However, if the target cell does not support handling of relay nodes, the serving base station obtains this information by receiving a dedicated rejection cause included in the HANDOVER FAILURE and HANDOVER PREPARATION FAILURE messages in case of S1 handover (see FIG. 4), or in the HANDOVER PREPARATION FAILURE message in case of X2 handover (see FIG. 6) in response from the target base station, whereby handover to the target cell in question is avoided, see step 104.

The rejection cause can simply indicate that the target cell does not support handling of relay nodes. Reuse of the existing cause “HO Target not Allowed” or a general reject cause is possible for indication of HO rejection. Such rejection cause is however not informative about the true reject cause.

The rejection cause can also be more specific, for example to state that the target cell does not support handling of relay nodes since it is a relay node itself. Other more specific causes could state that the target cell does not support handling of relay nodes because hardware or software does not support handling of relay nodes.

Depending on the specific rejection cause, the source eNB can store rejection information, se optional step 105, and avoid subsequent handover preparations since they can be considered intractable. For example, a rejection due to that the target cell is a relay node itself will render subsequent handover preparation failures as well.

### Proactive Cell Attribute Relay Node Indications

This embodiment is illustrated in general terms with a flowchart in FIG. 11.

According to this embodiment, information indicating if a target base station 150 and/or a target cell 150A for possible handover of a relay node from a serving base station 130 supports handling of relay nodes is obtained in step 111 as neighbor relation information.

When X2 is established between a first and a second base station, this can be used to inform about relay node support of served cells. Thus, neighbor relation information may be received over an X2 interface between the serving base station 130 and a potential target base station 150 serving a potential target cell 150A.

In step 112, the serving, or source, base station 130 determines that a served relay node 140 should be handed over to a target cell 150A served by a target base station 150.

Thus, when a target cell supports handling of relay nodes according to neighbor cell information, handover may be triggered to that target cell, see step 113, while in case a target cell does not support handling of relay nodes according to neighbor cell information, handover to that cell is avoided, see step 114.

For example, in LTE, information indicating capacity of relay node support can be included in served cell information element included in the X2 SETUP REQUEST, X2 SETUP RESPONSE or eNB CONFIGURATION UPDATE message. When a first eNB lacks relay node support capacity, then this is reflected in the served cell information. Moreover, when the first eNB, or one or more cells served by the first eNB, starts supporting relay nodes, this triggers a new eNB CONFIGURATION UPDATE message to all second eNB with which the first eNB have established X2 connections. The message includes relay support capacity information for the affected served cells.

Similarly, when a first eNB becomes a donor eNB to a relay node it sends an eNB CONFIGURATION UPDATE message, adding the relay node as one (or several if the relay node serves multiple cells) served cell to add, where the served cell information states that the added cell (or cells) does not support handling of relay nodes.

This means that a base station, such as an eNB, has updated information about which cells served by neighboring base stations that actually supports relay nodes. Consequently, intractable handover preparations to a target cell that does not support handling of relay nodes can be avoided, since the relay node support status of target cells is known in the base station.

As an alternative, the information about neighbor cell relay node support can also be conveyed to the eNB via a management system node, such as an operation and maintenance node, typically as part of, or associated to, neighbour cell relation information configured by the management system in an eNB. This information comprises PCI to ECGI associations, connectivity information, whether X2 establishment as well as handover is allowed, whether eNB is allowed to remove the relation or not, etc. This information can be extended to also include information about relay node support. The information regarding neighbor cell relay node support can be conveyed during information exchange between eNB and the management system, for example when a new neighbor relation is added.

Thus, according to the embodiments where information indicating target cell relay node support is disclosed via neighbor relation information, the information is conveyed to the serving, or source, base station prior to the handover need has been determined by the serving base station.

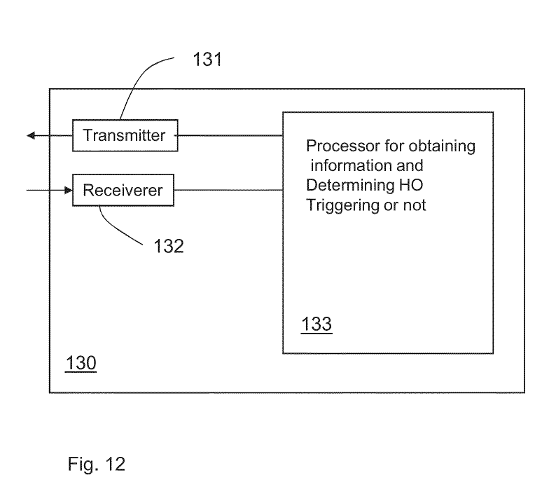

FIG. 12 illustrates schematically a base station 130, e.g. an eNodeB. It should be obvious that arrangements not related to this invention have been omitted for clarity. The base station 130 comprises a processor 133 configured to obtain information indicating if the target base station 150 and/or the target cell 150A supports handling of relay nodes. According to a specific embodiment, a transmitter, 131, is configured to send handover preparation signaling to the target base station 150, said handover preparation signaling comprising an indication that said handover preparation concerns a relay node. According to this embodiment, a receiver 132 is configured to obtain information if the target base station 150 and/or the target cell 150A support handling of relay nodes or not by receiving a response from the target base station.

The processor 133 may optionally comprise circuitry for storing information related to the rejection of handover, for example the cause of the rejection.

According to an alternative embodiment, the receiver 131 is configured to receive neighbor cell relation information to obtain the information indicating if the target base station 150 and/or the target cell 150A supports handling of relay nodes or not, said information being comprised in neighbor cell relation information. The receiver 131 may be configured to receive neighbor cell relation information over an X2 interface established between the serving base station 130 and the target base station 150, or via a management system node, such as an operation and maintenance node.

The processor 133 is furthermore configured to use said information to determine if handover of said relay node 140 should be triggered or not such that handover of the relay node 140 is avoided in case the target base station 150 and/or the target cell 150A does not support handling of relay nodes.

It should be noted that in different embodiments the processor may be configured to perform several different and/or alternative substeps.

The method steps performed by the base station 130 are performed by functional elements of the processing circuitry in the processor 133. In some embodiments these functions are carried out by appropriately programmed microprocessors or microcontrollers, alone or in conjunction with other digital hardware, which may include digital signal processors (DSPs), special-purpose digital logic, and the like. Either or both of the microprocessors and digital hardware may be configured to execute program code stored in memory. Again, because the various details and engineering tradeoffs associated with the design of baseband processing circuitry for wireless base stations are well known and are unnecessary to a full understanding of the invention, additional details are not shown here.

Program code stored in the memory circuit may comprise one or several types of memory such as read-only memory (ROM), random-access memory, cache memory, flash memory devices, optical storage devices, etc., and includes program instructions for executing one or more telecommunications and/or data communications protocols, as well as instructions for carrying out one or more of the techniques described herein, in several embodiments. Of course, it will be appreciated that not all of the steps of these techniques are necessarily performed in a single microprocessor or even in a single module.

Thus, embodiments of the invention may provide a method in a base station, such as an eNB, for avoiding intractable relay node handover attempts from a source eNB to a target eNB. Such method may comprise disclosing the non-support of relay nodes from neighbor relation information or by a relay node indication in the handover preparation, and by the reception of a handover preparation failure with a reject cause stating relay node non-support.

The neighbor relation information may be updated by relay support information per served cell from neighboring eNBs.

The neighbor relation information may be updated by relay support information via a management system, such as an operation and maintenance system.

The neighbor relation information may be updated by relay support information via a network node.

The neighbor relation information may be updated based on previous handover preparation attempts involving relay nodes.

The reject cause stating relay node non-support may provide more specific non-support information. Such specific non-support information may include information that the target cell is a relay node and/or that the target eNB lacks hardware support or software support for relay nodes.

The specific non-support information may be used to update the neighbor relation information.

The present invention may, of course, be carried out in other ways than those specifically set forth herein without departing from essential characteristics of the invention. The present embodiments are to be considered in all respects as illustrative and not restrictive.

1-24. (canceled)

25. A method, in a serving base station, for controlling handover of a relay node to a target cell controlled by a target base station, the method comprising:
obtaining information indicating if the target base station and/or the target cell supports handling of relay nodes or not;
avoiding handover of the relay node to the target cell in response to the information indicating that the target base station and/or the target cell does not support handling of relay nodes.

26. The method of claim 25:
further comprising indicating to the target base station, in handover preparation signalling, that the handover preparation concerns a relay node;
wherein the obtaining information comprises receiving a response from the target base station.

27. The method of claim 26 wherein the handover preparation signaling takes place over an S1 interface via a Mobility Management Entity.

28. The method of claim 26 wherein the handover preparation signaling takes place over an X2 interface between the serving base station and the target base station.

29. The method of claim 26 wherein the response comprises a rejection of handover in case the target base station and/or the target cell does not support handling of relay nodes.

30. The method of claim 29 wherein the response comprises information relating to the cause for the rejection of handover.

31. The method of claim 29 wherein the rejection of handover comprises a HANDOVER PREPARATION FAILURE message.

32. The method of claim 29 further comprising storing information related to the rejection of handover.

33. The method of claim 25 wherein the information indicating if the target base station and/or the target cell supports handling of relay nodes or not is obtained as neighbor relation information.

34. The method of claim 33 wherein the neighbor relation information is received over an X2 interface between base stations.

35. The method of claim 34 wherein the neighbor relation information is comprised in an eNB CONFIGURATION UPDATE message.

36. The method of claim 33 wherein the neighbor relation information is received via a management system node.

37. A base station capable of acting as serving base station, the base station comprising a processor, the processor configured to control handover of a relay node to a target cell controlled by a target base station by:
obtaining information indicating if the target base station and/or the target cell supports handling of relay nodes or not;
avoiding handover of the relay node to the target cell in response to the information indicating that the target base station and/or the target cell does not support handling of relay nodes.

38. The base station of claim 37 further comprising:
a transmitter configured to indicate to the target base station, in handover preparation signalling, that the handover preparation concerns a relay node;
a receiver configured to obtain the information by receiving a response from the target base station.

39. The base station of claim 38 wherein the transmitter is configured to send the handover preparation signaling over an S1 interface via a Mobility Management Entity.

40. The base station of claim 38 wherein the transmitter is configured to send the handover preparation signaling over an X2 interface between a serving base station and a target base station.

41. The base station of claim 38 wherein the response comprises a rejection of handover in case the target base station and/or the target cell does not support handling of relay nodes.

42. The base station of claim 41 wherein the response comprises information relating to the cause for rejecting handover.

43. The base station of claim 41 wherein the rejection of handover comprises a HANDOVER PREPARATION FAILURE message.

44. The base station of claim 41 wherein the processor comprises circuitry for storing information related to the rejection of handover.

45. The base station of claim 37 further comprising a receiver configured to receive neighbor relation information that comprises the information indicating if the target base station and/or the target cell supports handling of relay nodes or not.

46. The base station of claim 45 wherein the receiver is configured to receive the neighbor relation information over an X2 interface.

47. The base station of claim 46 wherein the receiver is configured to receive the neighbor relation information in an eNB CONFIGURATION UPDATE message.

48. The base station of claim 45 wherein the receiver is configured to receive the neighbor relation information via a management system node.
